(19) United States
(12) Patent Application Publication
(10) Pub. No.: US 2008/0102889 A1
(43) Pub. Date: May 1, 2008

(54) PORTABLE ELECTRONIC DEVICE AND METHOD FOR TRANSMITTING CALENDAR EVENTS

(75) Inventors: Darrell R. MAY, Waterloo (CA); Lawrence Edward KUHL, Waterloo (CA)

Correspondence Address: PERRY + CURRIER INC.;(FOR RIM), 1300 YONGE STREET, SUITE 500, TORONTO, ON, M4T-1X3, US

(73) Assignee: RESEARCH IN MOTION LIMITED, Waterloo (CA)

(21) Appl. No.: 11/554,144

(22) Filed: Oct. 30, 2006

(51) Int. Cl. H04M 1/00; H04B 1/38; H04Q 7/20

(52) U.S. Cl. 455/556.2; 455/566; 455/466

(57) ABSTRACT

A method of transmitting a calendar event from a portable electronic device includes receiving an attach calendar event command, attaching a selected calendar event to a message in response to the calendar event command, receiving a send command associated with the message, and transmitting the message including the calendar event for an addressee, in response to receipt of a send command.

### FIELD OF TECHNOLOGY

The present disclosure relates to transmission of calendar events from a portable electronic device.

### BACKGROUND

Portable electronic devices including, for example, smart telephones and wireless PDAs are becoming increasingly common and typically integrate functions of personal information management such as calendaring, messaging, World Wide Web browsing and telecommunications in a single device. Such devices run on a wide variety of networks from data-only networks such as Mobitex and DataTAC to complex voice and data networks such as GSMIGPRS, CDMA, EDGE, UMTS and CDMA2000 networks.

Calendar applications permit the user of the portable electronic device to schedule and review calendar events such as appointments and meetings on a visual display such as a liquid crystal display (LCD) screen.

Messaging applications such as Short Message Service (SMS) messaging, MultiMedia Message Service (MMS messaging) and electronic mail (email) messaging permit the user of the portable electronic device to send message to users of other electronic devices. The messaging application can be used for a variety of purposes including arranging a meeting time and/or place with the user of another electronic device. In this case, the user enters meeting related information into a message composition Graphical User Interface (GUI) and sends it to the intended recipient to provide the user of the other electronic device with the meeting information. The user of the portable electronic device can also enter the same information into a calendar event composition GUI to keep a record and even provide a reminder to the user when the date and time of the meeting approaches. Similarly, the user of the other electronic device can enter the same information into a calendar event composition GUI to keep a record of the scheduled meeting. Such multiple entry of data is inefficient.

It is therefore desirable to provide for more efficient data entry for providing calendar event information to other electronic devices.

### BRIEF DESCRIPTION OF THE DRAWINGS

The embodiments described herein will be better understood with reference to the following Figures, in which:

FIG. 1 is an overview of an exemplary communication system in which a portable electronic device according to one embodiment can be used;

FIG. 2 is a front view of an exemplary portable electronic device;

FIG. 3 is a block diagram of certain components, including internal components within the portable electronic device of FIG. 2;

FIG. 4 is an exemplary menu screen displayed on a display of the portable electronic device of FIG. 2;

FIG. 5 is a flowchart showing steps in a method of transmitting a calendar event from a portable electronic device, according to one embodiment;

FIG. 6 is a flowchart showing steps in a method of transmitting a calendar event from a portable electronic device, according to another embodiment;

FIG. 7 is a flowchart showing steps in a method of receiving and storing the calendar event received from the portable electronic device;

FIG. 8 is an exemplary screen showing a list of messages displayed in a message GUI of the portable electronic device of FIG. 2;

FIG. 9 is another exemplary screen showing a submenu of user options in the message GUI of FIG. 8;

FIG. 10 is another exemplary screen showing a message composition GUI displayed on the portable electronic device;

FIG. 11 is another exemplary screen showing a submenu of user options displayed in the message composition GUI of FIG. 10;

FIG. 12 is another exemplary screen showing a calendar view GUI displayed on the portable electronic device;

FIG. 13 is another exemplary screen showing a submenu of user options displayed in the calendar GUI of FIG. 12;

FIG. 14 is another exemplary screen, similar to the screen of FIG. 10, and showing a calendar event attached to the message;

FIG. 15 is another exemplary screen showing a submenu of user options displayed in the message composition GUI of FIG. 14;

FIG. 16 is another exemplary screen showing a calendar view GUI with a calendar event selected, displayed on the portable electronic device;

FIG. 17 is another exemplary screen showing a submenu of user options displayed in the calendar GUI of FIG. 16; and

FIG. 18 is a front view of another exemplary portable electronic device.

### DETAILED DESCRIPTION OF THE EMBODIMENTS

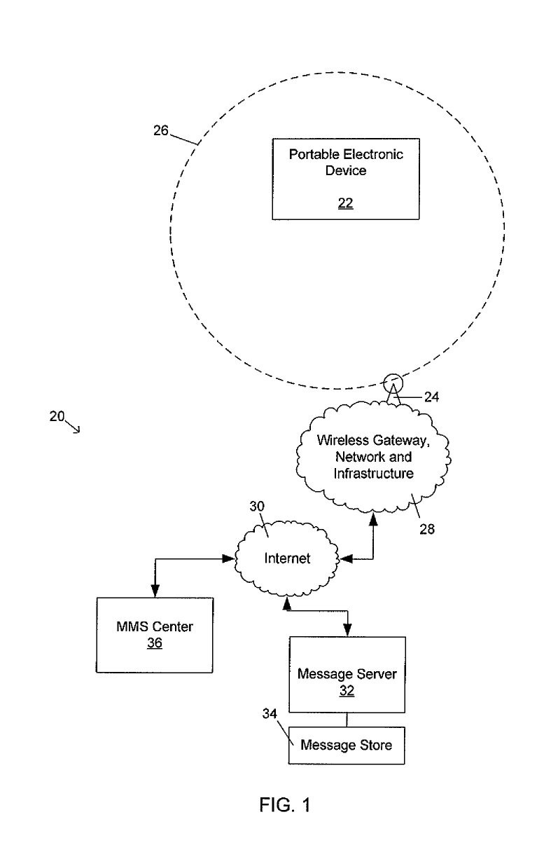

Reference is first made to FIG. 1 which shows an overview of an exemplary communication system in which a portable electronic device 22 can be used. The communication system is indicated generally by the numeral 20 and the exemplary portable electronic device is indicated by the numeral 22. The communication system 20 provides for communications with portable electronic devices including the exemplary portable electronic device 22, as shown. The portable electronic device 22 and the communication system 20 are operable to effect communications over a radio communications channel therebetween. Data originating at the portable electronic device 22 is communicated to the communication system 20 by way of the radio communications channel. Similarly, data originating at the communication system 20 is communicated from the communication system 20 to the portable electronic device 22 by way of the radio communications channel, thereby providing data to the portable electronic device 22.

For the purpose of illustration, the communication system 20 is functionally represented in FIG. 1 and a single base station 24 is shown. The base station 24 defines a coverage area, or cell 26 within which communications between the base station 24 and the portable electronic device 22 can be effectuated. It will be appreciated that the portable electronic device 22 is movable within the cell 26 and can be moved to coverage areas defined by other cells that are not illustrated in the present example. The communication system 20 includes a base station 24 that is part of a wireless network and infrastructure 28 that provides a link to the portable electronic device 22. The wireless network and infrastructure 28 includes a number of base stations (not shown) that provide the other cells referred to above. Data is delivered to the portable electronic device 22 via wireless transmission from the base station 24. Similarly, data is sent from the portable electronic device 22 via wireless transmission to the base station 24.

Wireless networks and infrastructures include, for example, data-centric wireless networks, voice-centric wireless networks, or dual-mode wireless networks. For the purpose of the present exemplary embodiment, the wireless network and infrastructure 28 includes a dual-mode wireless network that supports both voice and data communications over the same physical base stations.

The wireless network and infrastructure 28 is connected through the Internet 30 to a message server 32, to thereby provide a link between the message server 32 and the portable electronic device 22. An email message is sent by an email sender connected somewhere to the Internet 30. Such email messages typically use traditional Simple Mail Transfer Protocol (SMTP), RFC 822 headers and Multipurpose Internet Mail Extension (MIME) parts to define the format of the email message. These techniques are known and are well understood by those skilled in the art. The email message arrives at the message server 32 and is stored in a message store 34. Many messaging systems rely on a “pull” system in which the portable electronic device requests that stored messages be forwarded by the message server 32 to the portable electronic device 22. On the other hand, in some systems, such messages are automatically forwarded by the message server 32 to the portable electronic device. Regardless of the system, the email is delivered to the portable electronic device 22 (either by automatic forwarding or by request).

Similarly, an email message sent from the portable electronic device 22 is sent to the message server 32, through the wireless gateway, network and infrastructure and the Internet. The message server 32 receives the email message and forwards the email message on based on the addressee.

The wireless network and infrastructure 28 is also connected through the Internet 30 to a Multimedia Message Service (MMS) center 36, to thereby provide a link between the MMS center 36 and the portable electronic device 22. MMS messages are sent by an MMS sender using an MMS address such as the telephone number of the portable electronic device 22. The MMS messages addressed for the portable electronic device 22, are received at the MMS center 36 for delivery to the portable electronic device 22. Similarly, an MMS message sent from the portable electronic device 22 is sent to a home MMS center of the addressee of the MMS message, for delivery to the addressee's electronic device.

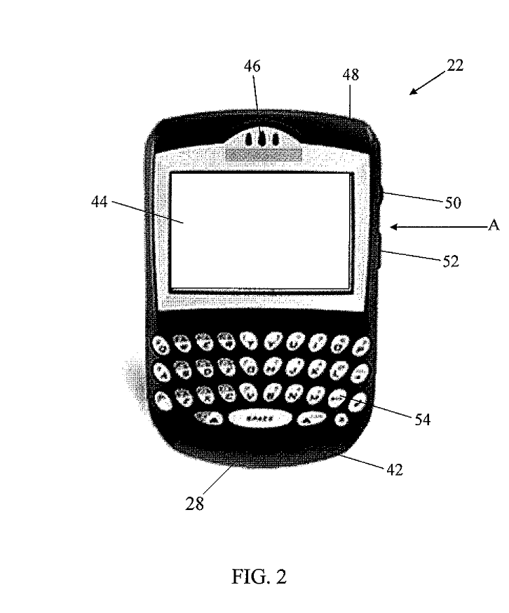

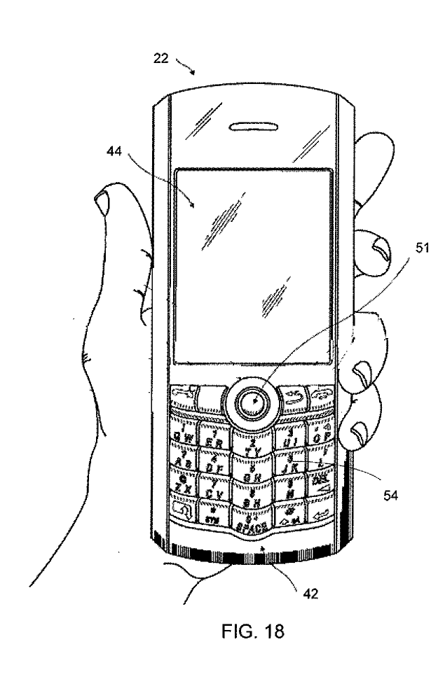

Referring now to FIG. 2, there is shown an exemplary portable electronic device 22 for message display in accordance with an embodiment. In the present embodiment, the portable electronic device 22 is based on the computing environment and functionality of a hand-held wireless communication device. It will be understood, however, that the portable electronic device 22 is not limited to a hand-held wireless communication device. Other portable electronic devices are possible, such as cellular telephones, smart telephones, and laptop computers. Referring again to the present embodiment, the portable electronic device 22 includes a housing 42 that frames an LCD display 44, a speaker 46, an LED indicator 48, a trackwheel 50 or trackball 51 (as described below and shown in FIG. 18), an exit key 52, a key pad 54, and a microphone 56. The trackwheel 50 and the exit key 52 can be inwardly depressed along the path of arrow “A” as a means to provide additional user-input. The housing 42 is made from a suitable material as will occur to those skilled in the art, and can be stored, for example, in a holster (not shown) that includes an attachment for attaching to a user's belt.

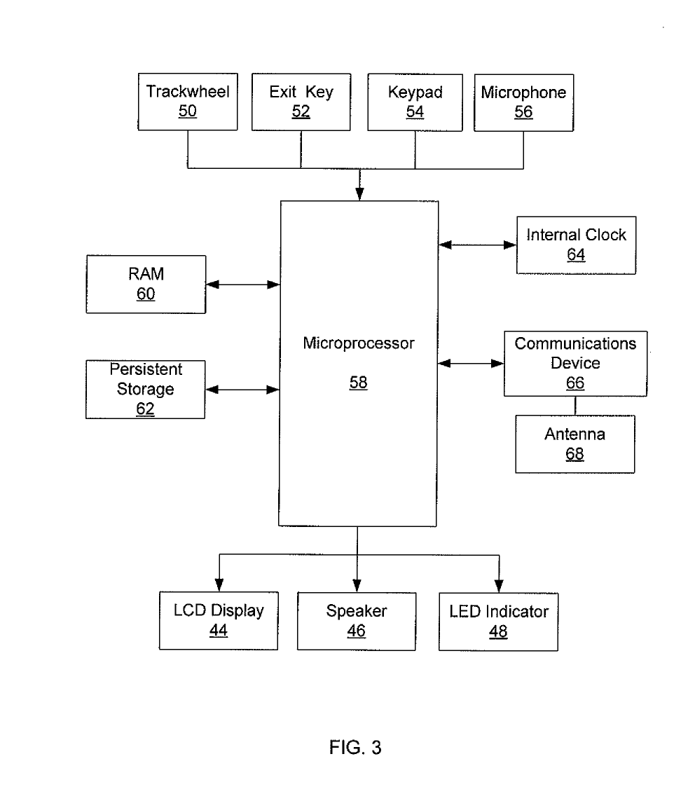

Referring now to FIG. 3, a block diagram of certain components, including internal components within the portable electronic device 22, is shown. The portable electronic device 22 is based on a microcomputer that includes a microprocessor 58 connected to a random access memory (RAM) unit 60 and a persistent storage device 62 that is responsible for various non-volatile storage functions of the portable electronic device 22. Operating system software executable by the microprocessor 38 is stored in the persistent storage device 62 which in the present embodiment is flash memory. It will be appreciated, however, that the operating system software can be stored in other types of memory such as read-only memory (ROM). The microprocessor 58 receives input from various input devices including the trackwheel 50, the exit key 52, and the keypad 54, and outputs to various output devices including the LCD display 44, the speaker 46 and the LED indicator 48. The microprocessor 58 is also connected to an internal clock 64.

In the present embodiment, the portable electronic device 22 is a two-way RF communication device having voice and data communication capabilities for communication with the communications system 20 as referred to above. Two-way RF communication is facilitated by a communications device 66 that is used to connect to and operate with the communication system 20, via the antenna 68.

For data communication, signals are received, for example, MMS messages, at the communications device 66, processed and sent to the microprocessor 58 where the signals are further processed for display on the LCD display 44. Data, such as MMS messages can also be composed using one or more of the input devices such as the key pad 54 or the trackwheel 50. The data is sent through the communications device 66 to the network to which the portable electronic device 22 connects. Although not shown, a battery provides power to all active elements of the portable electronic device 22.

The persistent storage device 62 also stores a plurality of applications executable by the microprocessor 58 that enable the portable electronic device 22 to perform certain operations including the communication operations referred to above. Other applications software is provided such as, for example, messaging applications including SMS messaging and email messaging applications, a Web browser application, an address book application, a calendar application, a profiles application, and others.

It will be appreciated that email messages are received at the portable electronic device 22 by data communication through the communication system 20 referred to above. Email messages are also sent from the portable electronic device 22 by data communication through the communication system 20 referred to above.

It will also be appreciated that MMS messages are received at the portable electronic device 22 by data communication through the communication system 20 referred to above. Similarly, MMS messages are sent from the portable electronic device 22 by data communication through the communication system 20 referred to above.

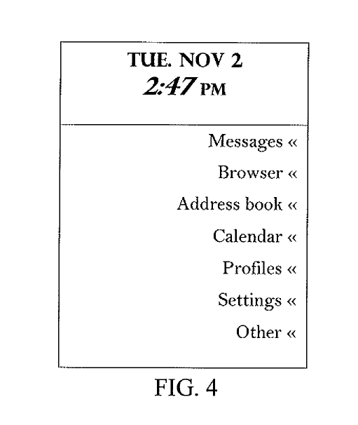

Referring to FIG. 4, there is shown an exemplary menu screen that is displayed on the LCD display 44 of the portable electronic device 22. The exemplary menu screen includes a display clock that is updated according to the internal clock 64, and applications such as a Messages application that includes an email messaging application, an MMS application and an SMS application, a Browser application for Web browsing, an Address book, and a Calendar application. A Profiles option, a Settings option and an Other option are also provided. Each of the displayed applications are selectable by, for example, scrolling to the desired application using the trackwheel 50 and pressing inwardly on the trackwheel 50 in the direction of arrow “A”.

The Calendar application is used for displaying and storing time-dependent calendar events such as appointments, lectures, exams, movies, meetings, performances, dinners, ceremonies, etc., when executed by the microprocessor 58. Each calendar event includes a variety of information including, for example, a date and time of the event. Each calendar event can also include other information such as names of other people attending the calendar event, a location or address of the calendar event or any other information. Selection of the Calendar application on the LCD display 44 of the portable electronic device 22 causes the microprocessor 58 to execute the Calendar application, thereby providing a default calendar display view of the calendar GUI to the LCD display 44 for the user of the portable electronic device 22. The default calendar display view can be any one of a day view, a week view, a month view and an agenda view. The calendar display view can be changed by the user, using the trackwheel 50 or keypad 54. Also, the default display view can be changed by the user using the trackwheel 50 or the keypad 54.

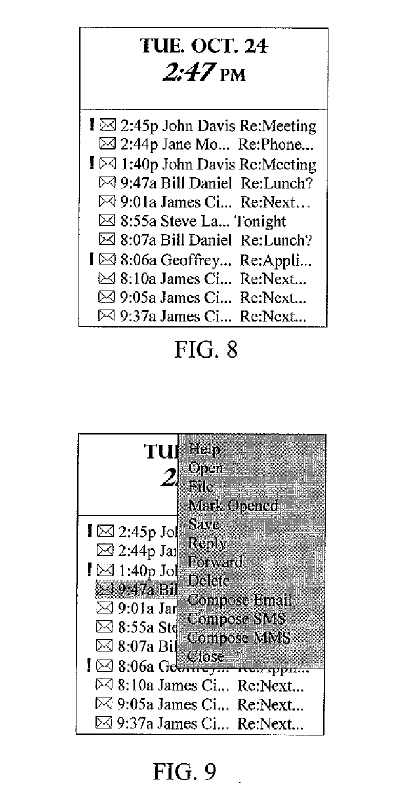

Selection of the Messages application causes execution of the Messages application by the microprocessor 58 and a list of messages including sent and received, opened and unopened email messages, MMS messages and SMS messages that remain on the portable electronic device 22, is displayed. It will be appreciated that the list of messages displayed on the portable electronic device 22 is not limited to all messages sent and received that remain on the portable electronic device 22. It is possible that the list of messages that are sent and received are displayed in separate lists and that only one of these lists, such as the list of messages received at the portable electronic device 22, is displayed upon selection of the Messages application. It is also possible that the messages are displayed in separate lists depending on the message type. Thus, email messages can be displayed in a list separate from an MMS message list and separate from an SMS message list. The list of messages is referred to as the list of message headers. Each message that is sent from the portable electronic device 22 and received at the portable electronic device 22 is represented by a header in the list. An exemplary list of messages sent and received is shown in FIG. 8.

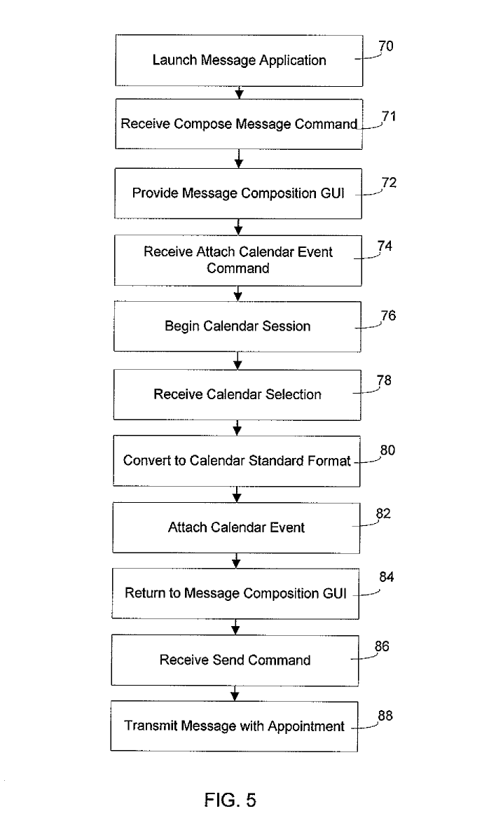

Reference is now made to FIG. 5 to describe an embodiment of the present application. It will be appreciated that each of the steps of FIG. 5 are carried out by routines and subroutines of software executed by the microprocessor 58. Coding of software for carrying out the steps in FIG. 5 is well within the scope of a person of ordinary skill in the art. The Messages application is executed by the microprocessor 58 upon user selection of the Messages application from the menu screen (step 70). The message composition GUI is provided via the LCD display 44 (step 72) in response receipt of a compose message command at the microprocessor 58 (step 71) as a result of user selection of a compose message option. Next an attach calendar event command is received by user selection of an attach calendar event option from a submenu of the message composition GUI (step 74). Upon receipt of the attach calendar event command, the microprocessor 58 begins a calendar session by executing the Calendar application, thereby providing the user with a calendar view such as a day view, a week view, a month view or an agenda view (step 76). A calendar event selection is received by user selection of one of the calendar events displayed in the calendar view (step 78), and the calendar event is converted to a format compliant with a calendar standard for calendar data exchange such as iCalendar [see: IETF RFC 2445, “Internet Calendaring and Scheduling Core Object Specification (iCalendar)”, November 1998, Dawson et al. (http://www.ieff.org/rfc/rfc2445.txt); IETF RFC 2446, “iCalendar Transport-Independent Interoperability Protocol (iTIP) Scheduling Events, BusyTime, To-dos and Journal Entries”, November 1998, Silverberg et al. (http://www.ietf.org/rfc/rfc2446.txt); and IETF RFC 2447, “iCalendar Message-Based Interoperability Protocol (iMIP)”, November 1998, Dawson et al. (http://www.ieff.org/rfc/rfc2447.txt)] or vCalendar [see V1.0 Specification, “vCalendar The Electronic Calendaring and Scheduling Exchange Format Version 1.0”, September 1996 (http://www.imc.org/pdilvcal-10.doc)], as will be understood by those skilled in the art (step 80). The calendar event is then attached to the message by inserting into the message (step 82), and the portable electronic device 22 returns to the message composition GUI, now with the attached calendar event in the message (step 84). Upon receipt of the send command by user selection of a send option (step 86), the message is transmitted from the portable electronic device 22 (step 88).

Referring still to FIG. 5, the method of transmitting a calendar event from the portable electronic device 22 will now be described by way of example. Again, coding of software for carrying out the steps described is well within the scope of a person of ordinary skill in the art. Upon selection of the Messages application from the menu screen of FIG. 4, the Messages application is executed by the microprocessor 58, causing the LCD display 44 to display the list of messages, as show in FIG. 8 and referred to above (step 70). The user of the portable electronic device 22 can optionally exit the message application by pressing inwardly on the exit key 52, in the direction of arrow “A”. In the present example, the user presses inwardly on the trackwheel 50 to cause the display of a submenu of user options in the Messages application, such as the exemplary submenu options shown in FIG. 9. As shown, the user is provided with options including Help, Open, File, Mark Opened, Save, Reply, Forward, Delete, Compose Email, Compose SMS, Compose MMS and Close. The exact number of options provided and the displayed names of those options is not important. The selection of each of the options causes the portable electronic device 22 to act in different ways. For example, user selection of the Help option results in the display of further user options for subject areas for which the user is seeking information. User selection of the Open option causes the display of the message that is highlighted in the list of messages for viewing by the user. Selection of the File option results in the display of a number of user-selectable folders such as inbox, sent, draft and trash folders in which to save the message that is highlighted in the list of messages. Selection of the Mark Opened option causes the message to be marked as opened by the user. Selection of the Save option causes the message to be saved in a saved messaged list. Selection of the Reply option provides a message composition GUI for replying to the sender of the message highlighted in the list of messages. Selection of the Forward option also provides a message composition GUI for forwarding the message highlighted in the list of messages. Selection of the Delete option causes the deletion of the message that is highlighted in the list of messages. Selection of any one of the Compose Email, Compose SMS and Compose MMS options causes the message composition GUI to be displayed for the respective one of Email, SMS and MMS messages. Selection of the Close option causes the submenu to be closed, thereby returning to the list of messages displayed in FIG. 8.

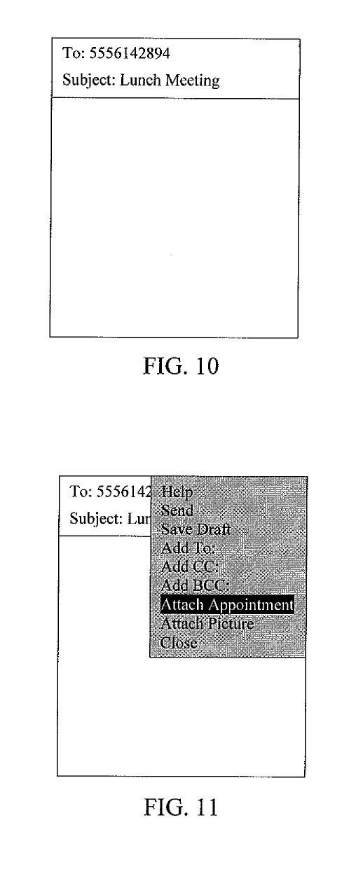

In the present example, the user selects the Compose MMS option from the submenu of FIG. 9 resulting in receipt of a compose MMS message command at the microprocessor 58 (step 71) causing the display of the message composition GUI for composing an MMS message, as shown in FIG. 10. It will be appreciated that the To and Subject fields of the MMS message are user-selectable for populating using the keypad 54. Alternatively, the To field is populated by user selection from a list of recipients stored in the Address book. It will also be appreciated that if the user selects the Reply option from the submenu of FIG. 9, the To field is automatically populated with the MMS address (such as the cellular telephone number) of the sender of the highlighted message in the list of messages. Similarly, the Subject field automatically includes the same subject as that of the highlighted message from the list of messages.

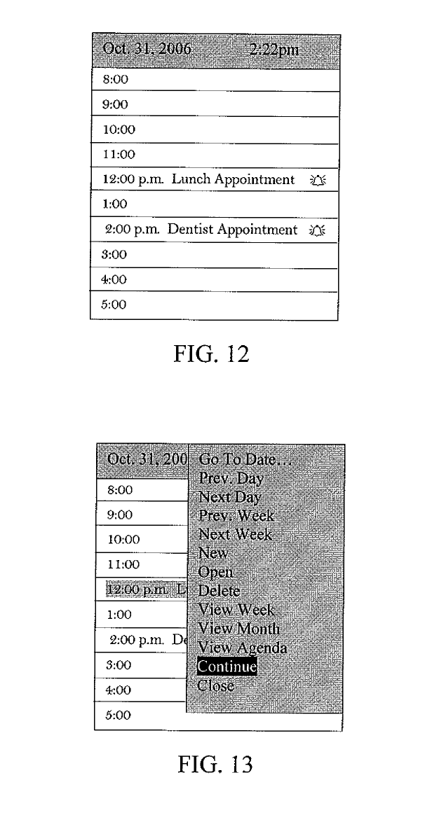

Next, the user requests the display of the submenu of options shown in FIG. 11, by pressing inwardly on the trackwheel 50 in the direction of the arrow “A”. Again, the user is provided with a number of user-selectable options. One such option includes an Attach Appointment option, the selection of which results in receipt of an attach calendar event command at the microprocessor 58 (step 74). Upon receipt of the attach calendar event command at the microprocessor 58, the microprocessor executes the Calendar application, thereby launching a calendar application session and providing a default calendar display view of the calendar GUI to the LCD display 44 for the user of the portable electronic device 22 (step 76). As shown in FIG. 12, the default calendar display view in the present example is a day view. The user then proceeds to viewing the calendar date from which the user wishes to select a calendared event. In the present example, the user proceeds to the day view for Oct. 31, 2006, which includes a lunch appointment at 12:00 p.m. and a dentist appointment at 2:00 p.m. Of course, the user can change to any other day or can change the calendar view as desired. The user then scrolls to the desired calendar event, which in the present example is the lunch appointment, and presses inwardly on the trackwheel 50, causing display of the submenu as shown in FIG. 13 and providing the user with a number of selectable options. One such selectable option from the submenu shown in FIG. 13 is the Continue option, the selection of which causes the selection of the lunch appointment calendar event. Thus, the microprocessor receives the selected calendar event (step 78) and converts the calendar event data to a format compliant with a calendar standard, for example, the iCalendar standard or vCalendar standard (step 80). Following conversion, the calendar event is attached to the MMS message as a part of the body of the message (step 82) and the calendar application closes, causing the LCD display 44 to return to the message composition GUI as shown in FIG. 13 (step 84). As shown, the lunch meeting appears in the message composition GUI, as a part of the body of the MMS message. Next, the user requests the display of the submenu of options shown in FIG. 15, by pressing inwardly on the trackwheel 50 in the direction of the arrow “A”. As shown, the submenu of options in FIG. 15 is similar to that shown in FIG. 11. At this point, user selection of the Send option causes a send command to be received at the microprocessor 58 (step 86), which results in the transmission of the MMS message along with the attached calendar event from the portable electronic device 22 (step 88).

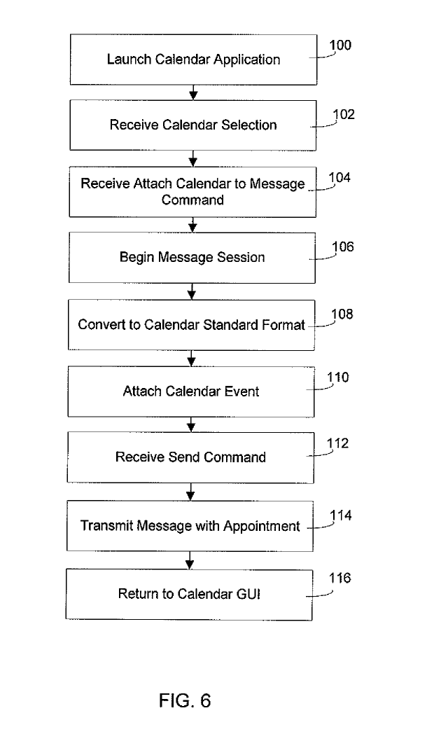

Another embodiment will now be described with reference to FIG. 6. It will be appreciated that each of the steps of FIG. 6 are carried out by routines and subroutines of software executed by the microprocessor 58. Coding of software for carrying out the steps in FIG. 6 is well within the scope of a person of ordinary skill in the art. In the present embodiment, the Calendar application is executed by the microprocessor upon user selection of the Calendar application from the menu screen, thereby providing the user with a calendar view (step 100). A calendar event selection is then received by user selection of one of the calendar events displayed in the calendar view (step 102). Next, an attach calendar event to a message command is received at the microprocessor 58 by user selection of a send calendar event option from a submenu of the calendar GUI (step 104). In response to receipt of the attach calendar event command, the microprocessor 58 begins a message session by executing the Messages application, thereby providing the user with a message composition GUI (step 106). The selected calendar event is also converted to a format complaint with a calendar standard for calendar data exchange (step 108) and is attached to the message by inserting the calendar event into the message (step 110). Upon receipt of a send command by user selection of a send option (step 112), the message is transmitted from the portable electronic device 22 (step 114). The portable electronic device 22 then returns to the calendar GUI to again display the calendar view (step 116).

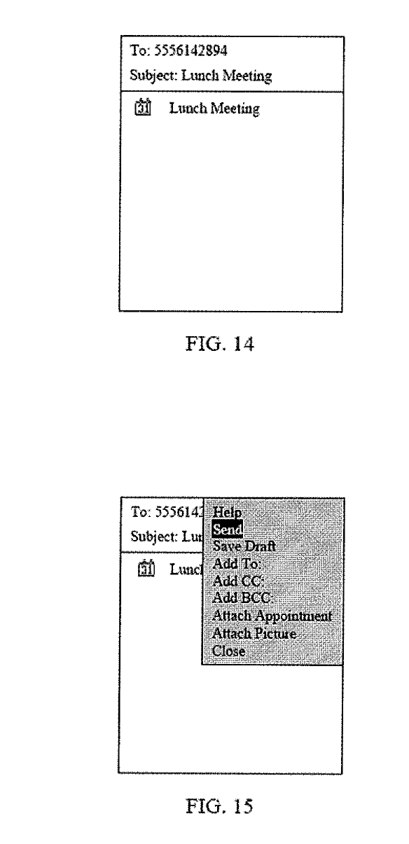

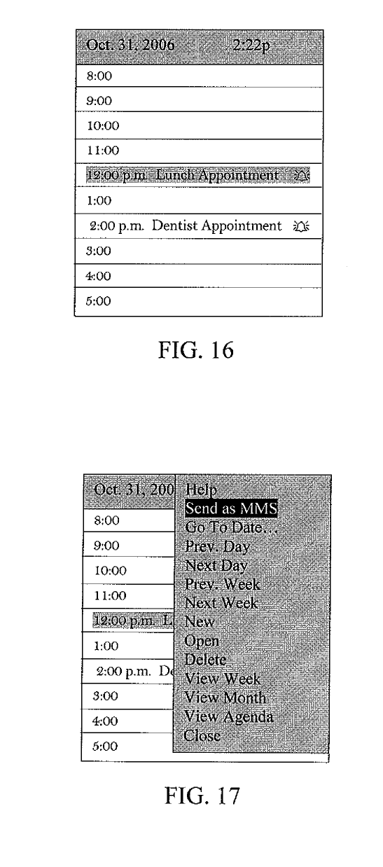

Referring still to FIG. 6, the method of transmitting a calendar event from the portable electronic device will now be described by way of example. Again, coding of software for carrying out the steps described is well within the scope of a person of ordinary skill in the art. Upon selection of the Calendar application from the menu screen of FIG. 4, the Calendar application is executed by the microprocessor 58, causing the default calendar display view of the calendar GUI to be displayed on the LCD display 44, as shown in FIG. 16 (step 100). The user then scrolls to the desired calendar event using the trackwheel 50 and presses inwardly on the trackwheel 50, causing the calendar event to be selected and resulting in the display of the submenu shown in FIG. 17 (step 102). It will be appreciated that the submenu of FIG. 17 is similar to that shown in FIG. 13. In the present example, however, a Send as MMS option is provided, rather than a Continue option. User selection of the Send as MMS option sends an attach calendar event to an MMS message command to the microprocessor 58 (step 104). In response to receipt of the attach calendar event to an MMS message command at the microprocessor 58, the microprocessor 58 executes the Messages application, thereby beginning an MMS message session (step 106). The calendar event is then converted to a format compliant with a calendar standard (step 108) and attached to an MMS message as a part of the body of the MMS message (step 110) for which a message composition GUI is provided via the LCD display 44, as shown in FIG. 14 (step 110). Again, the To and Subject fields are populated in a suitable manner. Next, the user requests the display of the submenu of options shown in FIG. 15, by pressing inwardly on the trackwheel 50 in the direction of the arrow “A”. User selection of the Send option causes a send command to be received at the microprocessor 58 (step 112), which results in the transmission of the MMS message along with the attached calendar event from the portable electronic device 22 (step 114). Following user selection of the Send option, the Messages application closes, causing the LCD display 44 to return to the calendar view shown in FIG. 12 (step 116).

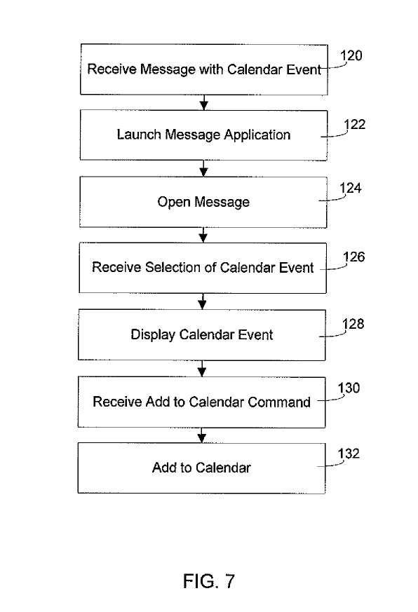

Referring now to FIG. 7, it will be appreciated that the portable electronic device 22 can receive messages with calendar events attached (step 120). After such a message is received, the user of the portable electronic device 22 selects the Messages application for execution by the microprocessor 58, resulting in the display of the list of messages including the received message with the calendar event attached (step 122). The message with the calendar event attached is opened (step 124) by, for example, scrolling to the message, pressing inwardly on the trackwheel 50, followed by selection of the Open option from the submenu shown in FIG. 9. The message is then displayed on the LCD display 44 and the user scrolls to the attached calendar event and selects the event by, for example, pressing inwardly on the trackwheel 50 (step 126) causing display of a submenu of options including a display calendar event option. Selection of the display calendar event option causes the details of the calendar event to be displayed (step 128). The user then adds the calendar event to the calendar database for display in the calendar view by, for example, pressing inwardly on the trackwheel 50 to cause the LCD display 44 to display a submenu of options including an add to calendar option. Selection of the add to calendar option causes receipt of an add to calendar command at the microprocessor 58, resulting in the calendar event being saved to the calendar database for viewing in the calendar view.

The above examples are described with specific reference to MMS messages. MMS messaging is advantageous for sending calendar events between portable electronic devices that do not support email messaging, for example. It will be appreciated, however, that calendared events can be transmitted by email as well.

It will be appreciated that the portable electronic device of FIG. 2 is shown for exemplary purposes only. Other portable electronic devices such as that shown in FIG. 18 are possible. Referring to FIG. 18, another exemplary portable electronic device 22 is shown. The portable electronic device 22 includes a housing 42 that frames an LCD display 44. In the present example, however, the portable electronic device 22 includes a trackball 51, rather than a trackwheel. The trackball 51 can be depressed as a means to provide additional user-input. The microprocessor 58 receives input from the trackball 51 which is used for user selection of features from a list or a table on the LCD display 44 of the portable electronic device 42. Selection is carried out by rolling the trackball to roll a cursor (or highlighted region), for example, to the desired selection and pressing inwardly on the trackball. The portable electronic device 22 shown in FIG. 18 includes many other features, including, for example, a key pad 54 and other features similar to those described above with reference to FIGS. 2 and 3. It will also be appreciated that reference is made to a trackwheel in the above description for exemplary purposes only, and a trackball 51 such as that shown in FIG. 18 can be used.

According to one aspect, there is provided a method of transmitting a calendar event from a portable electronic device. The method includes: receiving a compose message command; providing a message composition graphical user interface (GUI) for composing a message in response to the receiving the compose message command; receiving an attach calendar event command; providing a calendar session in response to receipt of the attach calendar event command; receiving a selection of the calendar event; attaching the calendar event to the message; returning to the message composition GUI; and transmitting the message including the calendar event for an addressee in response to receipt of a send command.

According to another aspect, there is provided a method of transmitting a calendar event from a portable electronic device, the method includes: receiving an attach calendar event command; attaching a selected calendar event to a Multimedia Message Service (MMS) message in response to the calendar event command; receiving a send command associated with the MMS message; and transmitting the MMS message including the calendar event for an addressee, in response to receipt of a send command.

According to yet another aspect, there is provided a portable electronic device. The portable electronic device includes a memory; a communications device for receiving and transmitting data; a display device; a user input device; and a processor. The processor is connected to the memory, the display device, the user input device, and the communications device for executing a program stored in the memory to cause the portable electronic device to: provide a message GUI on the display device for composing a message in response to receiving a compose message command from the user input device; provide a calendar session in response to receipt of an attach calendar event command from the user input device; attach a calendar event to the message in response to receipt of a selection of the calendar event; and transmit the message including the calendar event via the communications device, in response to receipt of a send command from the user input device.

According to still another aspect, there is provided a computer program product for transmitting a calendar event from a portable electronic device, the computer program product comprising a computer-readable medium having computer-readable code embodied therein for: receiving a compose message command; providing a message composition graphical user interface (GUI) for composing a message in response to the receiving the compose message command; receiving an attach calendar event command; providing a calendar session in response to receipt of the attach calendar event command; receiving a selection of the calendar event; attaching the calendar event to the message; returning to the message composition GUI; and transmitting the message including the calendar event for an addressee in response to receipt of a send command.

Advantageously, a calendar event can be sent to a user of another electronic device by selection of an attach calendar event command, thereby resulting in the attachment of the calendar event to a message. The message to which a calendar event is attached can be sent to other electronic devices, including other portable electronic devices, in a suitable format for viewing and saving on those portable electronic devices. Thus, the sender of the message can send the calendar event information after entry using the calendar application, without retyping the information in the calendar entry. This attachment of the calendar event in a message is easily carried out by the user as the user is provided a message composition GUI for composing the message and a calendar GUI for selecting the calendar event. In a particular aspect, the calendar GUI is provided in a calendar session that begins in response to receipt of a compose message command from a messaging GUI and ends after selection of the calendar event for attachment.

Many alternatives and variations to the above-described embodiments are possible, for example, many of the options provided in the submenus and the displayed details in the screens shown in the Figures are provided for exemplary purposes and such options and details can vary. Similarly, the names of many of the options can vary.

Still many other modifications and variations may occur to those skilled in the art. All such modifications and variations are believed to be within the sphere and scope of the present application.

1. A method of transmitting a calendar event from a portable electronic device, the method comprising:
receiving a compose message command;
providing a message composition graphical user interface (GUI) for composing a message in response to said receiving said compose message command;
receiving an attach calendar event command;
providing a calendar session in response to receipt of said attach calendar event command;
receiving a selection of the calendar event;
attaching the calendar event to said message;
returning to said message composition GUI; and
transmitting said message including said calendar event for an addressee in response to receipt of a send command.

2. The method according to claim 1, wherein said message comprises a Multimedia Message Service (MMS) message.

3. The method according to claim 1, wherein said providing a calendar session comprises launching a calendar application.

4. The method according to claim 3, wherein returning to said message composition GUI comprises closing said calendar application.

5. The method according to claim 1, wherein said providing a calendar session comprises providing a calendar GUI in which calendared events are displayed in one of a month view, week view, day view and agenda view.

6. The method according to claim 1, wherein attaching the calendar event comprises converting the calendar event to a format compliant with a standard for calendar data exchange.

7. The method according to claim 6, wherein converting the calendar event to a format compliant with a standard comprises converting the calendar event to a format compliant with an iCalendar standard.

8. The method according to claim 6, wherein converting the calendar event to a format compliant with a standard comprises converting the calendar event to a format compliant with a vCalendar standard.

9. The method according to claim 1, wherein said attaching the calendar event to the message comprises adding the calendar event to the body of the message.

10. A method of transmitting a calendar event from a portable electronic device, the method comprising:
receiving an attach calendar event command;
attaching a selected calendar event to a Multimedia Message Service (MMS) message in response to said calendar event command;
receiving a send command associated with said MMS message; and
transmitting said MMS message including said calendar event for an addressee, in response to receipt of a send command.

11. The method according to claim 10, wherein said receiving the attach calendar event command comprises receiving a selected attach calendar event command in a message Graphical User Interface (GUI).

12. The method according to claim 11, wherein said attaching comprises receiving a selection of a calendar event in a calendar GUI.

13. The method according to claim 12, wherein said attaching comprises converting the calendar event to a format compliant with a standard for calendar data exchange.

14. The method according to claim 10, wherein said receiving the attach calendar event command comprises receiving a selected send as message command in a calendar GUI.

15. The method according to claim 14, wherein said receiving a send command comprises receiving the send command in a message GUI.

16. The method according to claim 15, wherein said attaching comprises converting the calendar event to a format compliant with a standard for calendar data exchange.

17. A portable electronic device comprising:
a memory;
a communications device for receiving and transmitting data;
a display device;
a user input device; and
a processor connected to the memory, the display device, the user input device, and the communications device, for executing a program stored in the memory to cause the portable electronic device to:
provide a message GUI on said display device for composing a message in response to receiving a compose message command from said user input device;
provide a calendar session in response to receipt of an attach calendar event command from said user input device;
attach a calendar event to said message in response to receipt of a selection of the calendar event; and
transmit the message including the calendar event via the communications device, in response to receipt of a send command from said user input device.

18. A computer program product for transmitting a calendar event from a portable electronic device, said computer program product comprising a computer-readable medium having computer-readable code embodied therein for:
receiving a compose message command;
providing a message composition graphical user interface (GUI) for composing a message in response to said receiving said compose message command;
receiving an attach calendar event command;
providing a calendar session in response to receipt of said attach calendar event command;
receiving a selection of the calendar event;
attaching the calendar event to said message;
returning to said message composition GUI; and
transmitting said message including said calendar event for an addressee in response to receipt of a send command.
